(19) United States
(12) Patent Application Publication
(10) Pub. No.: US 2008/0111403 A1
(43) Pub. Date: May 15, 2008

(54) MODULE FOR A CUSHION

(75) Inventors: Thomas Ulbrich, Erdweg (DE); George Heinl, Zwingenberg (DE)

Correspondence Address: DOBRUSIN & THENNISCH PC, 29 W LAWRENCE ST, SUITE 210, PONTIAC, MI, 48342, US

(73) Assignee: W.E.T. AUTOMOTIVE SYSTEMS AG & ODELZHAUSEN AND PROSEAT GMBH & CO. KG

(21) Appl. No.: 11/936,462

(22) Filed: Nov. 7, 2007

(30) Foreign Application Priority Data
Nov. 14, 2006 (DE) 102006053850.1
Nov. 23, 2006 (DE) 102006055646.1
Jun. 13, 2007 (DE) 102007027828.6

(51) Int. Cl. B60N 2/56

(52) U.S. Cl. 297/180.12; 297/180.1; 297/463.2

(57) ABSTRACT

This invention relates to a module (30) for installation inside, in contact with or near a cushion element (20), a cushion element, a connecting means (60, 70) for a cushion element (20) and/or a module (30), and a padded object (5) having at least one module (30). Provision is made for the module (30) to feature at least a first connecting means (60) that corresponds to at least a second, at least partially matching, connecting means (70) of the cushion element (20).

### CLAIM OF PRIORITY

The present application claims priority from German Application Nos. DE 102006053850.1 filed Nov. 14, 2006; DE 102006055646.1 filed Nov. 23, 2006; and DE 102007027828.6 filed Jun. 13, 2007 disclosure of which is hereby incorporated by reference herein.

### FIELD OF THE INVENTION

This invention relates to a module for installation inside, in contact with or near a cushion element, a cushion element, a connecting means and a padded object according to the preambles of the independent claims, in particular for the temperature control or air conditioning of user-contact surfaces in the passenger compartment of a vehicle.

### BACKGROUND

There has been a long standing need to improve the efficiency of assembly operations of complex multi-part components (e.g. vehicle seats, covered steering wheel, door panels, and the like) while improving and increasing the functionality of the components. The assembly of individual components can be time consuming, costly and can lead to increased damage due to improper installation of the components. The present invention seeks to solve at least some of these issues by component integration and an improved anchorage system.

### SUMMARY

A technical concept according to the independent claims is proposed. Further advantageous embodiments are evident from the following description and the dependent claims.

The invention is useful for guiding a module, during the installation thereof, into a desired position relative to a cushion element, and/or for hindering any movement of the installed module alongside the cushion element, at least in one direction. The invention permits a reduction in the production costs for the installation of a plurality of systems, such as ventilation, sensor systems, etc., in a seat, and also makes for better anchorage of the installed systems. Moreover, defective parts can be exchanged more easily because they are not joined to the seat by means of bonding or sewing but by an easily releasable form-fitting connection. At the same time, additional fastening elements such as adhesive tape, hook-and-loop tape or rivets are rendered unnecessary. The installation process itself is faster because there is no need to wait for adhesives to cure, or to make seams. Furthermore, there is less waste, because, e.g., there is no silicone release paper from adhesive tapes.

In principle, the invention is suitable for all padded objects, in particular vehicle seats, seat pads, passenger compartment trim, armchairs, or, for example, office equipment.

Details of the invention are explained in the following: These explanations are intended to elucidate the invention. However, they are only of exemplary nature. The scope of the invention naturally allows for one or more of the described features to be omitted, modified or supplemented. Further it is self-evident that the features of different embodiments can be combined with each other.

### BRIEF DESCRIPTION OF THE DRAWINGS

Reference will be made hereinafter to:

FIG. 1 illustrates a side view of a vehicle and a seat in accordance with an aspect of the present invention.

FIG. 2 illustrates a perspective view of a seat cushion without a cover, with a first embodiment of a module in accordance with an aspect of the present invention.

FIG. 3 illustrates a perspective view of a seat cushion without a cover, with three alternative embodiments to FIG. 2 in accordance with an aspect of the present invention.

FIG. 4a) illustrates a section through the cushion of FIG. 3 in accordance with an aspect of the present invention.

FIG. 4b) illustrates another embodiment of a section through the cushion of FIG. 3 with pyramid-like protuberances and recesses as connecting means in accordance with an aspect of the present invention.

FIG. 4c) illustrates another embodiment of a section through the cushion of FIG. 3 with duct-like hollow spaces between the module and the seat cushion in accordance with an aspect of the present invention.

FIG. 4d) illustrates another embodiment of a section through the cushion of FIG. 3 with undercut recesses in accordance with an aspect of the present invention.

### DETAILED DESCRIPTION

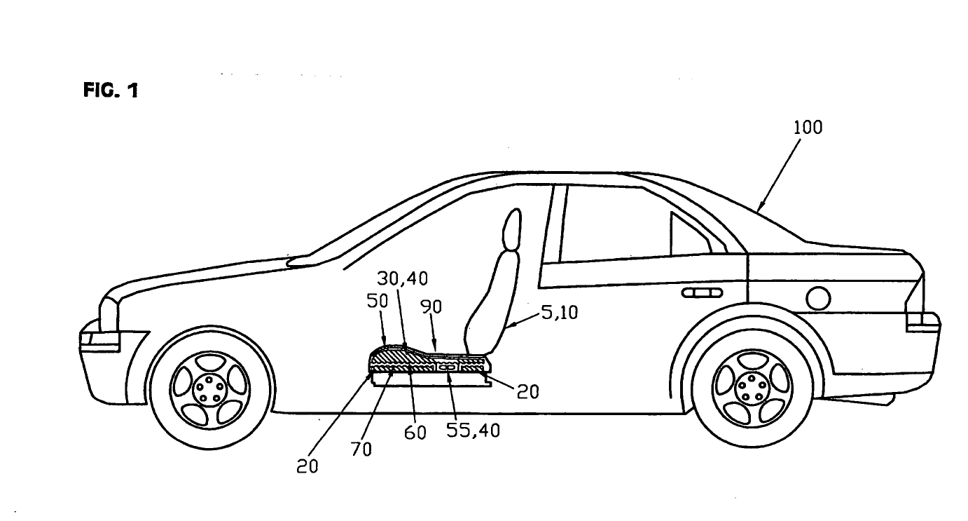

FIG. 1 shows a vehicle. The vehicle can be an airplane, a rail vehicle, a ship, or, as here, a motor vehicle.

The vehicle is provided with at least one object 5 that is at least partially padded, said object 5 preferably being a padded interior fitting. This can be, for example, the steering wheel, the dashboard, an armrest, a door trim panel, a seat pad, an electric blanket, or, as here, a seat 10.

The padded object 5 has at least one cushion element 20 and at least one cover 90 that covers the cushion element 20.

The padded object 5 is provided with at least one module 30. This is housed between the cover 90 and the cushion element 20. The term “module” refers here to a unit comprising a plurality of components, in which a large number of similar components and/or of functionally related components that perform a certain function are combined to form an assembly or a functional unit.

The module 30 preferably has at least one support 40. This may be essentially planar, stranded, disk-shaped or block-shaped.

The support 40 may be formed from one or more components (e.g. layers). Preferably, it is made up at least partially of a textile, a multiple- or single-thread knitted fabric, a woven or non-woven fabric, a flexible thermoplastic, a porous, air-permeable and/or open-cell material, a polymer foam, a knitted spacer fabric and/or a film. The material may be equally well permeable in all directions, or it may exhibit directional air permeability in order to channel air selectively to a passenger or to let the air flow along a surface to be padded.

The support preferably extends substantially in two dimensions along a surface to be padded and/or air-conditioned.

Provision may be made for the module to feature a plurality of supports. These are then preferably assigned to different zones to be padded, for example seat and backrest, or two surfaces separated by a trench, such as the central part of the seat and the side bolster. In this case, the supports are preferably interconnected mechanically and/or electrically on the side facing away from the seat cover.

The module 30 preferably features at least one temperature-control device 50. The term “temperature-control device” refers to every kind of device that can be used to selectively change the temperature of its surroundings. More particularly, it refers to every device featuring at least one electrical heating element, a heat pump, an electrical heating resistor, one or more stranded or textile heating conductors, a Peltier element and/or a fan, and/or is essentially comprised thereof.

Preferably, a heating element featuring a large number of stranded heating conductors is provided, which are preferably arranged such that they meander beside each other and which are connected electrically in parallel. These may, for example, be arranged on a support (not shown) of their own, for example a multiple-thread knit or a nonwoven. A film and/or a net of selectively activatable adhesive, for example hot-melt adhesive, may be deemed a particularly suitable choice of support for this purpose.

The invention also makes provision for at least one stranded electrical conductor to be sheathed, at least section-wise, with an adhesive, in particular a heat-activatable adhesive. This makes for straightforward assembly, for example on a support 40 made of foam.

The electrical conductor may feature at least one filament-like inner strand (not shown) and, surrounding it at least in part, an electrically conducting sheathing layer 35. The term “sheathing layer” refers here to a layer which, directly or indirectly, surrounds a strand at least in part but is not necessarily the outermost layer surrounding the strand.

As shown in FIG. 1, the module 30 may also be equipped with an air-conditioning device 55. By this is meant every kind of device that can be used for selectively changing the temperature and/or the humidity of its surroundings, and/or for air exchange. Such devices include, for example, the temperature-control devices already mentioned, moisture-absorbing substances such as activated carbon fibers, polymeric superabsorbers, the on-board air-conditioning device, an at least partially air-permeable spacer medium, a knitted spacer fabric and/or an air-conditioning insert.

For connecting it up to the on-board air-conditioning unit, the module 30 may be provided with a connection device that can be plugged into or connected with an appropriate supply line of the air-conditioning unit.

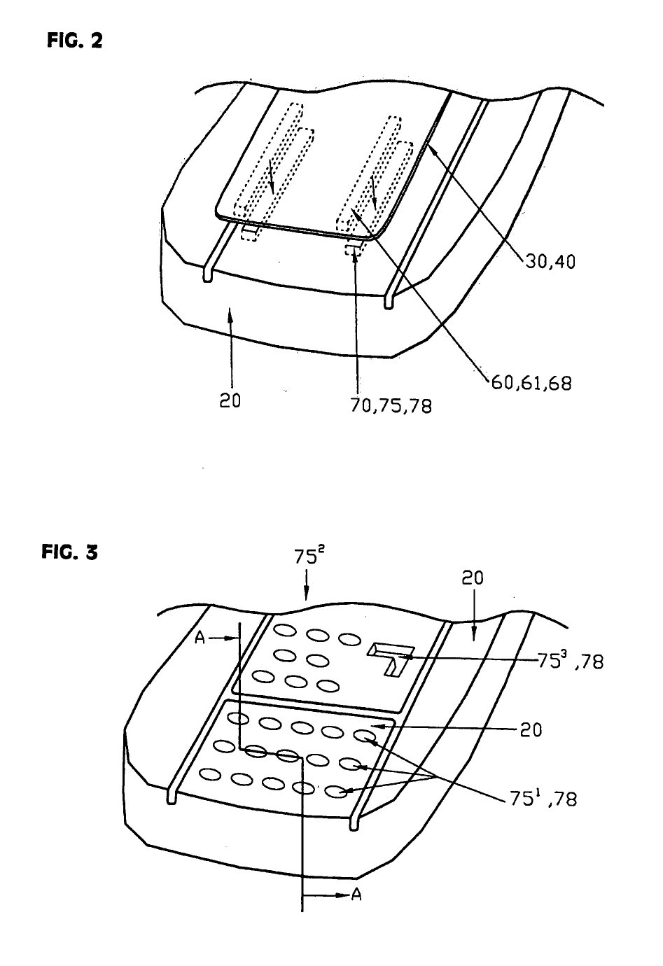

As shown in FIGS. 2 to 4, the module 30 preferably features at least one connecting means 60. The term “connecting means” refers here to a device that anchors the module, at least in one direction, relative to an object 5 to be padded, or hinders any displacement of the module in this direction, or guides and/or positions the module, at least in one direction, while it is being installed in contact with the padded object 5.

The connecting means 60 features at least one profiled zone, hereinafter referred to as the profiled zone 68. In the profiled zone 68, the surface of the connecting means 60 differs in height from the surface in the neighborhood of the profiled zone 68. By “height” is meant the direction perpendicular to the direction in which the connecting means 60 or the module 30 substantially extends. The term “neighborhood” refers here particularly to a zone that is on the same side of the module as the connecting means, to the average or predominant height of which it corresponds.

The connecting means 60 preferably features at least one protuberance 61 and/or a recess 65. These may be configured as, but not limited to, the shape of pins, webs, troughs, knobs, cubes, pyramids, cylinders, mushroom heads and/or hemispheres.

Preferably, as here, a multiplicity of profiled zones 68 is provided, which are disposed relative to each other in comb-like, egg-carton-like, grid-like and/or fish-scale fashion.

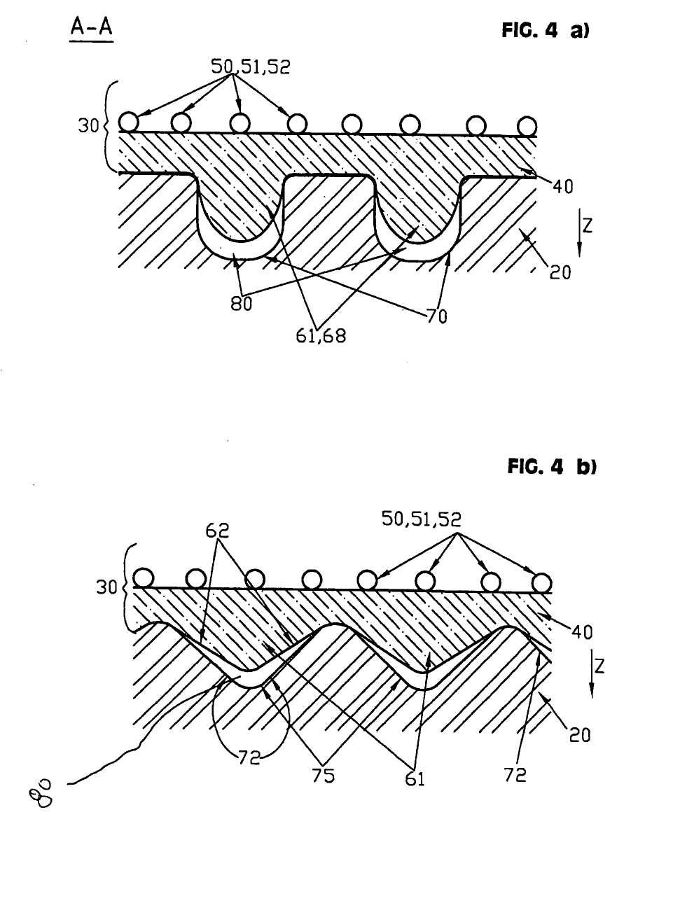

Depending on their purpose, the profiled zones 68 can differ in their position and number as well as their shape. For example, it may only be necessary to provide a limited number of anchorage points at specific relevant points or surface areas, for example at the corners of the module, in the middle and/or in zones subject to frequent contact. This is the case with the embodiment of FIG. 2 and the alternative 3 of FIG. 3. However, it is also possible to provide profiled zones 78 that are essentially distributed uniformly over the surface, as in FIG. 3 (first and second variants). The profiled zones may be arranged such that they are aligned in the surface, or else staggered in each case relative to the preceding zone.

The connecting means 60 and its profiled zones 68 may be formed, at least partially, in one piece with the support 40, i.e. as an integral part thereof. This is to advantage if, for example, the support 40 is made of a foamed material. However, it is also possible to attach the connecting means 60, or at least one profiled zone 68, separately, at least in part. This makes sense if, for example, the support 40 is made of a nonwoven. In such cases, bonded foam elements as shown in FIG. 2 are well suited as protuberances 61. They can be anchored by means of bonding, sewing, or similar processes.

The seat 10 preferably features at least one cushion element 20. This is preferably made, at least partially, of molded foam.

The cushion element 20 is likewise provided with a connecting means 70. The connecting means 70 features at least one profiled zone 78, which may be created according to the same considerations concerning structure and choice of material as for the profiled zone on the module. Preferably, it is created as an integral part of the cushion element 20, either inside or in contact with this, during the production thereof. It is preferably formed, at least partially, from the material of which the cushion element is made, and is preferably an integral part thereof.

At least one of the connecting means 60 of the module 30 and at least one connecting means 70 of the cushion element 20 match each other. By this is meant that their shapes correspond in such manner as to produce a desired, useful effect. This may be achieved, for example, by providing for the fitted connecting means 60, 70 to intermesh, at least partially. It would also be possible, however, for two recesses to be positioned one above the other such that they are congruent, and to connect them with each other by means of a separate fastener that belongs neither to the cushion element 20 nor to the module 30.

The connecting means 60, 70, or their profiled zones 68, 78, are preferably engineered such that their contours are identical or approximately mirror each other, and/or inversely.

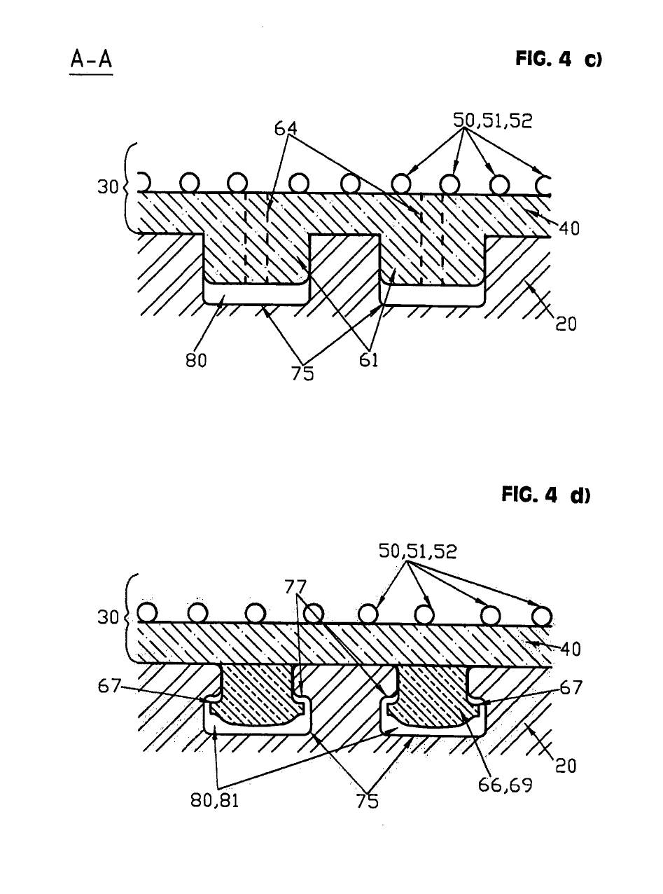

FIGS. 4a)-4d) shows some of many possible ways of matching the module's connecting means 60 with the connecting means 70 of the cushion element 20.

In the embodiment shown in FIG. 4a), the connecting means 60 of the module 30 is provided with a multiplicity of knob-shaped protuberances 61. These engage recesses 75 located in matching positions in the connecting means 70 of the cushion element 20. Depending on the choice of profiles, hollow spaces 80 remain between the module 30 and the cushion element 20. This configuration enables the hardness of the seat 10 to be adjusted. Larger hollow spaces 80 make for softer seating than smaller or non-existent hollow spaces.

FIG. 4b) shows an embodiment with pyramid-shaped protuberances 61 on the module 30 and pyramid-shaped recesses 75 on the cushion element 20. To simplify installation, it is to advantage if at least one flank of at least one protuberance and/or of at least one recess is inclined at an angle of less than 90° and more than 0° relative to the direction of installation Z, in which the profiles are made to engage. This angle is preferably between 30° and 85°. In this context, the inclinations of the recesses and protuberances are coordinated such that a hollow space 80 remains in the region of their flanks.

The embodiment of FIG. 4c) shows a cushion element 20 with cylindrical recesses 75 and matching cylindrical protuberances 61 on the module 30. This embodiment features hollow spaces 80, the longitudinal section of which is, at least partially, approximately rectangular. The module 30 features at least one opening 64 that connects the two sides of the module in order to permit the passage of air, at least on a localized basis, through the module 30. This opening 64 is preferably engineered as a cylindrical duct, one end of which opens approximately in the center of the hollow space 80, and which runs through the cylindrical protuberance 61 approximately in the middle thereof. In an embodiment of this kind, movements of a user on the seat surface cause compression and decompression of the module 30 and the cushion element 20, resulting in an alternating decrease and increase in the volume of the hollow space 80 and hence in improved air circulation at the seat contact surfaces—in other words, in passive air conditioning.

FIG. 4d) shows a module 30, in which a module 30 has a connecting means 60 featuring at least one profiled zone 68 in the form of an additional element 69 attached as a supplement to the module 30. This additional element is, for example, a foamed part bonded subsequently to the module. It is essentially cylindrical in shape but has an undercut 67, so that as a whole, the additional element has the shape of a mushroom head 66. The cushion element 20 is accordingly provided with at least one recess 75 which, for its part, features an undercut 77. This arrangement produces an approximately cylindrical blind hole 81 with a constricted opening. In an embodiment of this kind, the module 30 can be secured simultaneously against displacement in any spatial direction simply by placing it on the cushion element.

All of the embodiments illustrated in FIGS. 4a)-4d) show protuberances 61 and recesses 75 that are, in essence, rotationally symmetrical. However, the profiled zones 68, 78 could be engineered such that, at least in one dimension, they extend further. Knob-shaped protuberances would thus turn into webs, elbows, or zigzag or serpentine protuberances.

If, for example, the embodiment shown in FIG. 4c) were configured in this way, the result would be long, hollow spaces 80 with a rectangular cross-section and with openings 64 at regular or irregular intervals. Embodiments with long, hollow spaces of this kind could then serve, for example, as passive air-exchange means for air conditioning of the seat surface. They could also be supplied with ambient air and/or temperature-controlled and/or dehumidified air by way of a fan installed inside the module 30 or the cushion element 20, or of a connection, likewise installed therein, with the on-board air-conditioning device.

An embodiment (not shown) could provide for a fan and/or a connection with the on-board air-conditioning unit to be installed in contact with the module 30, also for the module to feature a multiplicity of profiled zones, and for at least some of these profiled zones to extend as far as the fan/connection so as to form air ducts that distribute air at least under part of the base of the module.

The profiled zones 68 and 78 of the module 30 and the cushion element 20 are preferably coordinated such that they can only be made to engage each other effectively in one position if this is practical for installation of the module 30, for example due to the position of the air-supply connections.

The embodiments shown in FIGS. 4a)-4d) are installed simply by placing the module 30 onto the cushion element 20. By virtue of their profiling, the connecting means 60, 70 then prevent any lateral displacement of the module 30 along the cushion element 20. In the case of webbed or ducted profiled zones, it may also be possible to insert the module 20 into the cushion element 30 from the side.

Appropriate undercuts 67, 77 are useful for holding the module 30 in the installation position and locking it in the desired end position. Alternatively, the module 30 can also be held by the cover 90, which is fitted later, of the seat 10.

Provision may also be made for the module 30 to be anchored to the cushion element 20 only at some of the entirety of profiled zones 68, 78 provided, preferably at the corners and in the central area of the module 30.

Provision is preferably made for at least partially intermeshing profiled zones 68, 78, or their protuberances 61 and recesses 65, to feature heights and depths respectively that differ from one another, so that, in the installed state, at least one hollow space is formed.

Preferably, provision is made for at least one hollow space 80 that extends predominantly in the longitudinal direction of the module 30 in order to transport air along the module, preferably between a profiled zone of the cushion element 20 and the profiled zone 68 of the module 30.

Accordingly, pursuant to one aspect of the present invention, there is contemplated a Module (30) for installation inside, in contact with or near a cushion element (20), is characterized in that the module (30) features at least a first connecting means (60), which at least partially matches at least a second connecting means (70) featured by the cushion element (20).

The invention may be further characterized by one or any combination of the features described herein, such as the Module is characterized in that the module (30) features at least one support (40), an air-conditioning device (55), a temperature-control device (50), a pressure sensor and/or a seat-occupancy recognition means and/or is essentially comprised thereof; characterized in that the module (30) and/or at least one of its components is foamed into at least one support (40), inserted into it, bonded onto it, or joined to it in another manner by a form-fitting or integral material connection.

Accordingly, pursuant to another aspect of the present invention, there is contemplated a Cushion element (20), characterized in that it features at least one connecting means (70), which at least partially matches at least one connecting means (60) of a module (30).

The invention may be further characterized by one or any combination of the features described herein, such as the connecting means (60, 70) for a cushion element (20) and/or a module (30), particularly according to one of the preceding claims, characterized in that said connecting means features at least one profiled zone (68, 78), at least one protuberance (61, 71) and/or at least one recess (65, 75) in order to engage at least one, at least partially matching, profiled zone (68, 78), recess (65, 75) or protuberance (61, 71) of an at least partially matching connecting means (60, 70); the connecting means (60, 70) is characterized in that it is fabricated at least partially from the same material as, and/or from a different material than, that of the module (30) and/or the cushion element (20) to which it belongs.

Accordingly, pursuant to yet another aspect of the present invention, there is contemplated a padded object (5) having at least one module (30), characterized in that the module (30) features a first connecting means (60) that engages a second, at least partially matching, connecting means (70) of the padded object (5).

The invention may be further characterized by one or any combination of the features described herein, such as the padded object (5) characterized in that, in the installed state, the module (30) and at least one cushion element (20) provided in contact with the padded object (5) and/or the connecting means (70) assigned to the padded object have a hollow space (80) between them.

### REFERENCE NUMERALS

5 Padded object
10 Seat
20 Cushion element
30 Module
35 Sheathing layer
40 Support
50 Temperature-control device
51 Electrical heating resistor
52 Electrical conductor
55 Air-conditioning device
56 Fan
60 Connecting means in contact with the module
61 Protuberance
62 Flank
65 Recess
67 Undercut
68 Profiled zone
64 Openings
66 Mushroom head
69 Additional element
70 Connecting means in contact with the cushion
71 Protuberance
72 Flank
75 Recess
77 Undercut
78 Profiled zone
80 Hollow space
81 Blind hole
90 Cover
100 Vehicle

1. A module for installation inside, in contact with or near a cushion element, characterized in that the module includes at least a first connecting means, which at least partially matches at least a second connecting means featured by the cushion element.

2. The module according to claim 1, wherein the module includes at least one support element and at least one component selected from the group of an air-conditioning device, a temperature-control device, a pressure sensor and a seat-occupancy recognition means.

3. The module according to claim 2, wherein at least one of its components is foamed into the at least one support element, inserted into it, bonded onto it, or joined to it in another manner by a form-fitting or integral material connection.

4. The module according to claim 1, wherein the cushion element, includes at least one connecting means, which at least partially matches at least one connecting means of the module.

5. The module according to claim 4, wherein the connecting means for the cushion element includes one profiled zone, one protuberance, one recess or any combination thereof in order to engage an at least partially matching profiled zone, protuberance, or recess in the connecting means for the module.

6. The module according to claim 1, wherein the connecting means for the module is fabricated at least partially from the same material as that of the cushion element.

7. The module according to claim 1, wherein that in the installed state, the module and the cushion element includes at least one hollow space defined therebetween.

8. The module according to claim 7, wherein a provision is made for the at least one hollow space to extend predominantly in a longitudinal direction of the entire module in order to transport air along the module.

9. A module for installation on a cushion member, comprising:
a support member that includes at least two surfaces separated by a trench and the support member is interconnected mechanically, electrically, or both on the side facing away from a cover member;
the module includes at least a first connecting means, which at least partially matches at least a second connecting means featured by the cushion element;
wherein that in an installed state, the module and the cushion element includes at least one hollow space defined therebetween and the module includes at least one opening to allow fluid communication between the at least one hollow space and a top surface of the module.

10. The module according to claim 9, wherein the connecting means for the module is fabricated at least partially from the same material as that of the cushion element.

11. The module according to claim 9, wherein a provision is made for the at least one hollow space to extend predominantly in a longitudinal direction of the entire module in order to transport air along the module.

12. The module according to claim 9, wherein the module includes at least one temperature-control device.

13. The module according to claim 12, wherein the at least one temperature-control device comprises at least one selected from the following group of an electrical heating element, a heat pump, an electrical heating resistor, and a stranded or textile heating conductor.

14. A module for installation on a cushion member, comprising:
the module fabricated at least partially from the same material as that of the cushion element, including at least a first connecting means, which at least partially matches at least a second connecting means featured by the cushion element, wherein the at least second connecting means for the cushion element includes one profiled zone, one protuberance, one recess or any combination thereof in order to engage an at least partially matching profiled zone, protuberance, or recess in the at least first connecting means for the module;
includes at least one support element; and
at least one temperature-control device disposed on a top surface of the module, wherein the at least one temperature-control device comprises at least one selected from the following group of an electrical heating element, a heat pump, an electrical heating resistor, and a stranded or textile heating conductor;
wherein that in an installed state, the module and the cushion element includes at least one hollow space defined therebetween and the module includes at least one opening to allow fluid communication between the at least one hollow space and the top surface of the module, further wherein a provision is made for the at least one hollow space to extend predominantly in a longitudinal direction of the entire module in order to transport air along the module.
